(19) United States
(12) Patent Application Publication
(10) Pub. No.: US 2002/0100716 A1
(43) Pub. Date: Aug. 1, 2002

(54) Constant pressure filtered water delivery system

(76) Inventor: Robert S. Bosko, San Antonio, TX (US)

Correspondence Address: LAW OFFICES OF CHRISTOPHER L. MAKAY, 1634 Milam Building, 115 East Travis Street, San Antonio, TX, 78205, US

(21) Appl. No.: 09/775,116

(22) Filed: Feb. 1, 2001

(51) Int. Cl. C02F 1/44

(52) U.S. Cl. 210/97; 210/321.6; 210/136

(57) ABSTRACT

A filtered fluid storage and delivery system generally comprises a filter assembly for filtering of a source fluid and an accumulator having a first chamber and a second chamber segregated one from the other by a flexible membrane. The inlet to the filter assembly is in fluid communication with a system inlet while one chamber of the accumulator assembly is in selective fluid communication, through a valve, with the system inlet. The other chamber of the accumulator is in fluid communication with the outlet from the filter assembly as well as a system outlet. Fluid passed through the filter assembly is stored in one chamber of the accumulator until needed. When needed, a valve is opened to allow the source fluid to enter the other chamber of the accumulator, thereby forcing the stored fluid from the accumulator at the source fluid pressure.

### FIELD OF THE INVENTION

The present invention relates to fluid purification systems. More particularly, the invention relates to a water filtering apparatus through which small to medium quantities of water may be economically periodically provided sans mineral and like impurities.

### BACKGROUND OF THE INVENTION

Many presently available devices require the periodic delivery of small quantities of mineral-free water for proper operation. In particular, many apparatus in the food services industry require such purified source water for the generation of hot water and/or steam. Exemplary of those devices requiring a source of purified water, are the steamer-type products commercially available from A.J. Antunes & Co. of Carol Stream, Ill. The exemplary products deliver a timed burst of source water to a burner for the generation of steam, which is then utilized to warm a food product. As those of ordinary skill in the art will recognize, however, the presence of minerals in the source water will quickly result in deposits of calcium and the like on the burners, which in turn requires the expenditure of much time and effort to clean.

As a result, it is necessary to provide a source of deionized water to these types of devices in order to prevent buildups. Unfortunately, a standard reverse osmosis filter system, capable of providing the necessary filtration, can easily cost as much as the steamer-type device itself. Additionally, a standard reverse osmosis filter system is often as large as the steamer-type device—a concern in the space conservative restaurant industry. What is more, a standard reverse osmosis filter system without a delivery pump utilizes air pressure in a storage chamber to force filtered water from the system. As a result, the output pressure from the reverse osmosis filter system will vary widely depending upon the amount of water in storage. This variation in output pressure is unacceptable for those devices which control the amount of water delivered through the timing of a valve opening and closing.

It is therefore an overriding object of the present invention to provide an economical source of deionized water for use with steamer-type products. It is a further object of the present invention to provide such a source wherein the output pressure may easily be regulated. Finally, it is an object of the present invention to provide such a source that is also of reasonable size for implementation in the crowded restaurant environment.

### SUMMARY OF THE INVENTION

In accordance with the foregoing objects, the present invention—a filtered fluid storage and delivery system—generally comprises a filter assembly for filtering of a source fluid and an accumulator having a first chamber and a second chamber segregated one from the other by a flexible membrane. The inlet to the filter assembly is in fluid communication with a system inlet while one chamber of the accumulator assembly is in selective fluid communication with the system inlet. The other chamber of the accumulator is in fluid communication with the outlet from the filter assembly as well as a system outlet.

In operation, fluid passed through the filter assembly is stored in one chamber of the accumulator until needed. When needed, a valve is opened to allow the source fluid to enter the other chamber of the accumulator, thereby forcing the stored fluid from the accumulator at the source fluid pressure. In at least one embodiment, source fluid is shutoff to the filter assembly when the chamber is at maximum capacity through the provision of a pressure feedback system. In another embodiment, a pressure regulator is provided at the system outlet.

Finally, many other features, objects and advantages of the present invention will be apparent to those of ordinary skill in the relevant arts, especially in light of the foregoing discussions and the following drawings, exemplary detailed description and appended claims.

### BRIEF DESCRIPTION OF THE DRAWINGS

Although the scope of the present invention is much broader than any particular embodiment, a detailed description of the preferred embodiment follows together with illustrative figures, wherein like reference numerals refer to like components, and wherein:

FIG. 1 shows, in functional block diagram, the constant pressure filtered delivery system of the present invention in an initial state;

FIG. 2 shows, in functional block diagram, the constant pressure filtered delivery system of FIG. 1 in a fully charged state;

FIG. 3 shows, in functional block diagram, the constant pressure filtered delivery system of FIG. 1 in a fully discharged state;

FIG. 4 shows, in functional block diagram, the constant pressure filtered delivery system of FIG. 1 as implemented with a pressure feedback controlled shut-off valve; and

FIG. 5 shows, in functional block diagram, the constant pressure filtered delivery system of FIG. 1 as implemented with an output pressure regulator.

### DETAILED DESCRIPTION OF THE PREFERRED EMBODIMENT

Although those of ordinary skill in the art will readily recognize many alternative embodiments, especially in light of the illustrations provided herein, this detailed description is exemplary of the preferred embodiment of the present invention, the scope of which is limited only by the claims appended hereto.

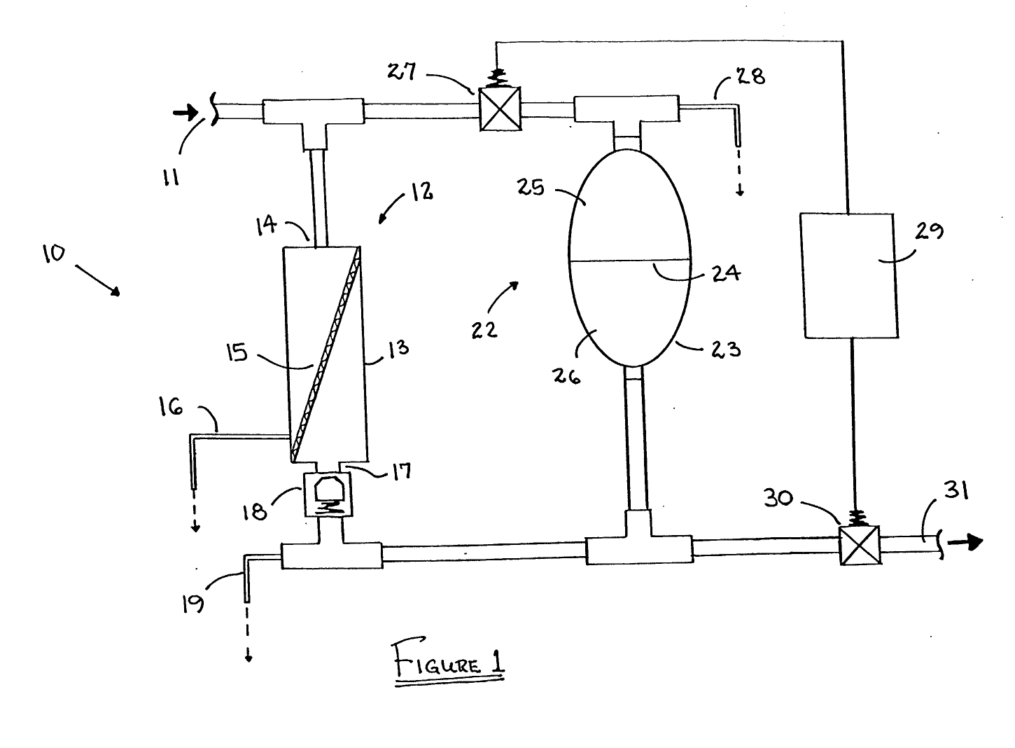

Referring now to the figures, the constant pressure filtered water delivery system 10 of the present invention is shown to generally comprise a reverse osmosis (“R/O”) filter assembly 12 and an accumulator assembly 22. As shown in the figures, the RIO filter assembly 12, which is typical of known assemblies, generally comprises an R/O filter vessel 13 having a source water inlet 14, an R/O membrane 15, a flow-restricted reject water drain 16 and a filtered water outlet 17, as known to those of ordinary skill in the relevant arts to be commercially available under the well-known trademark “OSMOTIK” from Osmosis Technology, Inc. of Buena Park, Calif. or other sources. As shown in FIGS. 1 through 3, the inlet 11 to the constant pressure filtered water delivery system 10 is in fluid communication with the source water inlet 14 to the filter vessel 13.

As also shown in the figures, the accumulator assembly 22 generally comprises a pressure vessel 23, divided by a flexible diaphragm 24 into a source water chamber 25 and a filtered water chamber 26. Such an accumulator assembly is readily accessible to those of ordinary skill in the relevant arts by modifying any of the well-known pressure accumulator tank products such as those that are commercially available from the Shurflo Pump Manufacturing Co. of Santa Ana, Calif. In particular, the commercially available pressure accumulator tank is modified by simply removing the compressible gas inlet port and replacing the same with a pipefitting. In this manner, both chambers may be utilized for liquid accumulation.

As shown in FIGS. 1 through 5, the system inlet 11 is in fluid communication with the source water chamber 25 through an interposed solenoid controlled source water valve 27. In this manner, source water pressure may be selectively delivered to the source water chamber 25 according to the state of the solenoid controlled source water valve 27. Although those of ordinary skill in the art will recognize many substantial equivalents, Applicant has found suitable for implementation of the present invention those solenoid piloted diaphragm valves commercially available under the trade designation “ECI” from Evolutionary Concepts, Inc. of San Dimas, Calif. As also shown in FIGS. 1 through 5, the R/O filter assembly 12 is in fluid communication with the filtered water chamber 26 through an interposed check valve 18. Through this communication, filtered water from the filtered water outlet 17 of the R/O filter vessel 13 may be forced into the filtered water chamber 26 for storage and later usage.

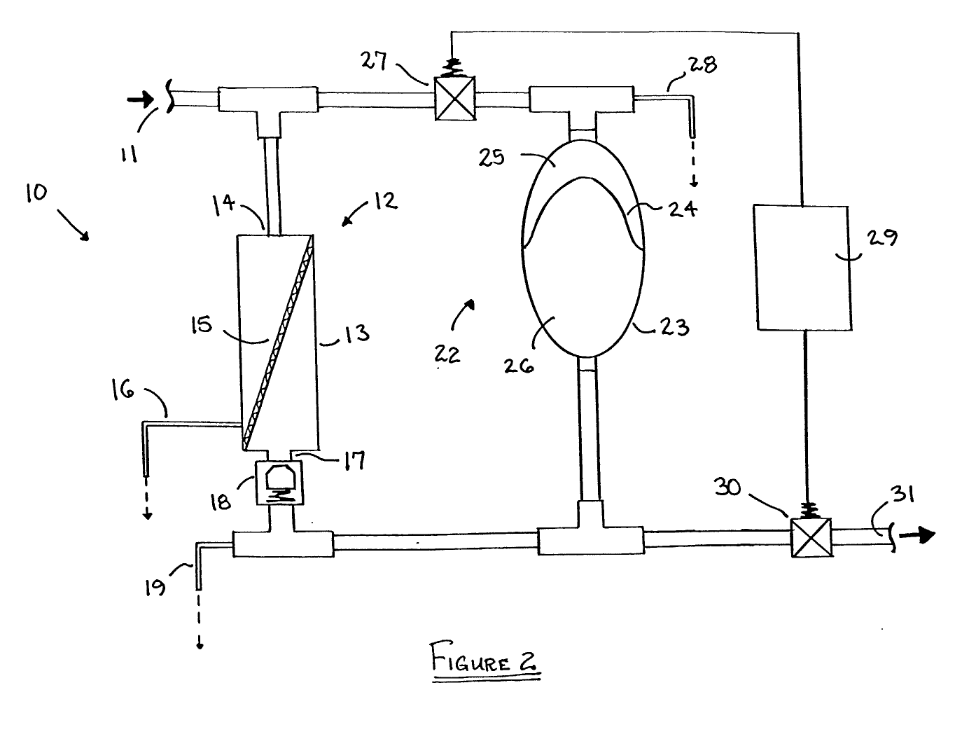

Under initial and/or static conditions, as depicted by FIG. 1, the flexible diaphragm 24 is at rest between the source water chamber 25 and the filtered water chamber 26. The solenoid controlled source water valve 27 is in a normally closed state as is a solenoid controlled outlet valve 30 provided at the system outlet 31. As will be better understood further herein, a valve must be provided in the system outlet 31 for operation of the present invention. Such a valve may, however, comprise an inlet valve to the apparatus to which filtered water from the present invention is delivered and, thus, not be included as part of the system 10. In the alternative, the outlet valve may be provided as shown in the figures. In any case, application of source water pressure to the system inlet 11 results in flow across the R/O membrane 15, through the check valve 18 and into the filtered water chamber 26. As shown in FIG. 2, filtered water entering chamber 26 displaces the flexible diaphragm 24 into the source water chamber 25. Any water or air in the source water chamber 25 is evacuated from the system 10 through a capillary pressure relief 28 in fluid communication with the source water chamber 25. Upon reaching a maximum pressure within the filtered water chamber 26, additionally produced filtered water may overflow through a capillary pressure relief 19 in fluid communication with the filtered water chamber 26.

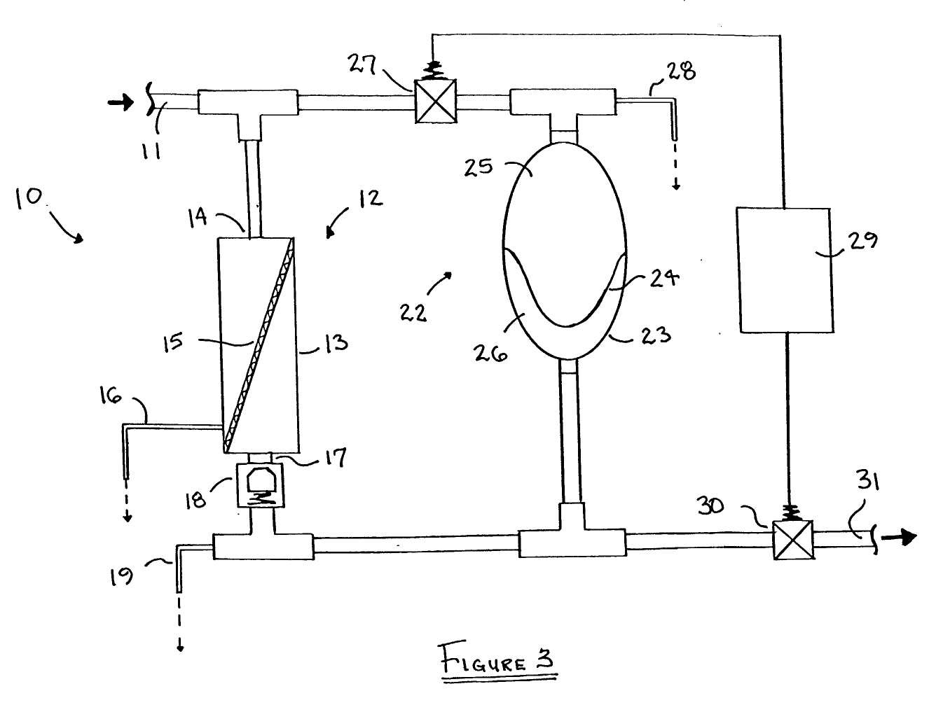

Whenever filtered water is demanded, the solenoid controlled outlet valve 30 is opened to provide fluid communication between the filtered water chamber 26 and the system outlet 31. In order to ensure constant output pressure, however, the solenoid controlled source water valve 27 is slaved to the solenoid controlled outlet valve 30 through a simple electrical connection or a provided controller 29 as appropriate for the particular implementation. Opening of the solenoid controlled source water valve 27 allows source water from the system inlet 11 to flow into the source water chamber 25, displacing the flexible diaphragm 24 toward the filtered water chamber 26, as particularly shown in FIG. 3. Because the capillary pressure relief 28 allows only a small flow to evacuate the system 10, the pressure applied to the flexible diaphragm 24 from the source water is essentially the pressure of the source water as delivered to the system inlet 11. This constant pressure is thereby delivered through the flexible diaphragm 24 to the filtered water chamber 26, resulting in a substantially constant output pressure at the system outlet 31. Because the capillary pressure relief 19 on the filtered water chamber 26 side of the flexible diaphragm 24 is also small compared to the system outlet 31, pressure is only negligibly affected. Upon delivery of the desired quantity of filtered water, the solenoid controlled outlet valve 30 and the solenoid controlled source water valve 26 are again closed, thereby allowing the filtering process to continue.

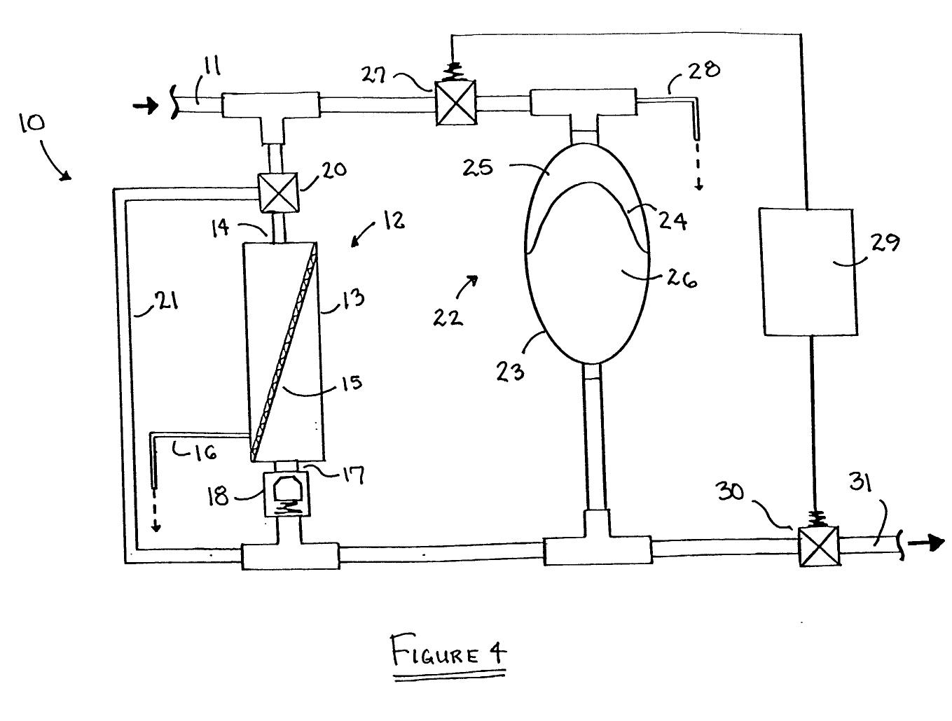

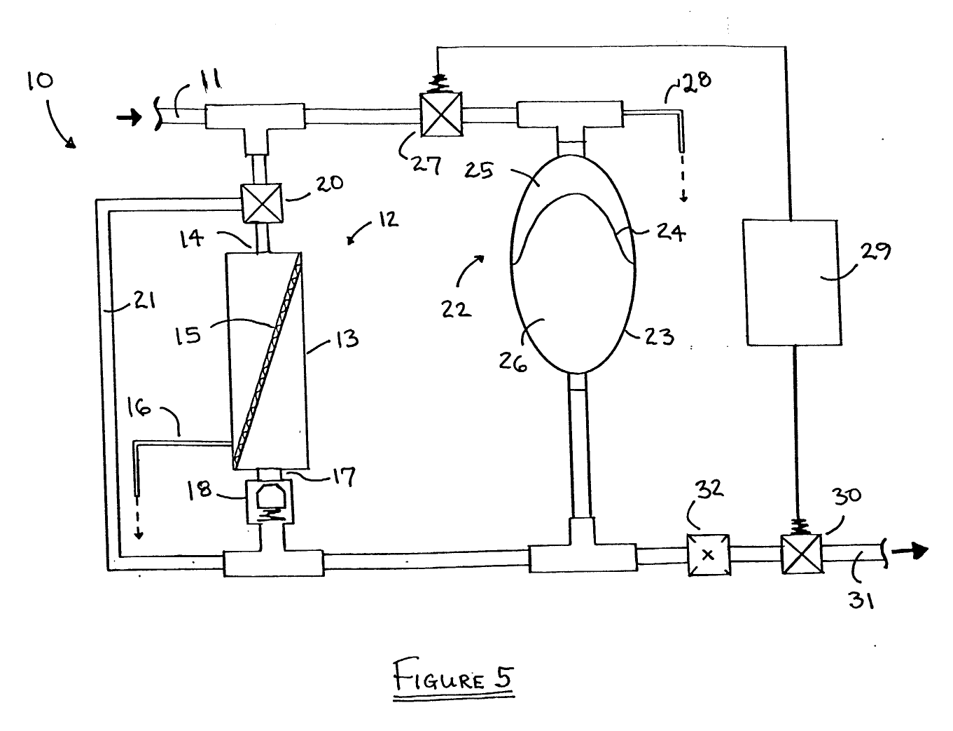

It is noted that the implementing engineer must take caution to ensure that the capillary pressure relief 19 from the filtered water chamber 26 is balanced with the capillary pressure relief 28 from the source water chamber 25 such that filtered water will in fact enter the filtered water chamber 26 rather than taking a path of lesser resistance through the capillary pressure relief 19. In the alternative, the capillary pressure relief 19 may be omitted in favor of a hydraulically controlled shut-off valve 20 as shown in FIGS. 4 and 5. In this embodiment, a pressure feedback line 21 from the filtered water chamber 26 causes the hydraulically controlled shut-off valve 20 to close upon reaching maximum pressure in the filtered water chamber 26. This embodiment has the additional advantage of ensuring that all available source water pressure through the system inlet 11 is directed to the source water chamber 25 during a filtered water delivery. Although those of ordinary skill in the art will recognize many substantial equivalents, Applicant has found suitable for implementation of the present invention valves such as are commercially available from Nimbus Water System, Inc. of San Marcos, Calif.

While the foregoing description is exemplary of the preferred embodiment of the present invention, those of ordinary skill in the relevant arts will recognize the many variations, alterations, modifications, substitutions and the like as are readily possible, especially in light of this description, the accompanying drawings and claims drawn thereto. For example, an output pressure regulator 32, which may be adjustable, may be provided in the output path as shown in FIG. 5. Such an output pressure regulator is commercially available from A.J. Antunes & Co. of Carol Stream, Ill., which is also a manufacturer of steamer-type products with which the present invention may be used to great advantage. In any case, because the scope of the present invention is much broader than any particular embodiment, the foregoing detailed description should not be construed as a limitation of the scope of the present invention, which is limited only by the claims appended hereto.

What is claimed is:

1. A filtered fluid storage and delivery system, said system comprising:
a system inlet for introduction to said system of a source fluid;
a filter assembly for filtering of the source fluid, said filter assembly having a filter inlet in fluid communication with said system inlet and a filter outlet;
an accumulator having a first chamber in fluid communication with said filter outlet and a second chamber in selective fluid communication with said system inlet, said first chamber and said second chamber being segregated one from the other by a flexible membrane; and
a system outlet in fluid communication with said first chamber.

2. The filtered fluid storage and delivery system as recited in claim 1, said system further comprising a first valve interposed said system inlet and said second chamber, said first valve being adapted to selectively enable fluid communication between said system inlet and said second chamber.

3. The filtered fluid storage and delivery system as recited in claim 2, wherein said first valve comprises a solenoid controlled valve.

4. The filtered fluid storage and delivery system as recited in claim 2, said system further comprising a first pressure relief, said first pressure relief being in fluid communication with said second chamber.

5. The filtered fluid storage and delivery system as recited in claim 4, wherein said first pressure relief comprises a valve.

6. The filtered fluid storage and delivery system as recited in claim 4, wherein said first pressure relief is adapted to enable evacuation of fluid from said second chamber under pressure against said membrane from fluid entering said first chamber.

7. The filtered fluid storage and delivery system as recited in claim 6, wherein said first pressure relief comprises a capillary.

8. The filtered fluid storage and delivery system as recited in claim 4, said system further comprising an outlet valve adapted to control fluid flow through said system outlet.

9. The filtered fluid storage and delivery system as recited in claim 8, wherein said first valve is slaved to said outlet valve such that opening of said outlet valve causes opening of said first valve.

10. The filtered fluid storage and delivery system as recited in claim 9, wherein closing of said outlet valve causes closing of said first valve.

11. The filtered fluid storage and delivery system as recited in claim 9, said system further comprising a controller, said controller being adapted to effect opening and closing of said first valve based upon the state of said outlet valve.

12. The filtered fluid storage and delivery system as recited in claim 9, wherein said outlet valve comprises a solenoid controlled valve.

13. The filtered fluid storage and delivery system as recited in claim 9, said system further comprising a pressure regulator adapted to limit fluid pressure delivered through said outlet.

14. The filtered fluid storage and delivery system as recited in claim 13, wherein said pressure regulator is adjustable.

15. The filtered fluid storage and delivery system as recited in claim 4, said system further comprising a check valve, said check valve being adapted to prevent fluid flow from said accumulator to said filter assembly.

16. The filtered fluid storage and delivery system as recited in claim 4, said system further comprising a second pressure relief, said second pressure relief being in fluid communication with said first chamber.

17. The filtered fluid storage and delivery system as recited in claim 16, wherein said second pressure relief comprises a capillary.

18. The filtered fluid storage and delivery system as recited in claim 16, wherein said second pressure relief is balanced with said first pressure relief such that said second pressure relief resists greater fluid flow than does said first pressure relief.

19. The filtered fluid storage and delivery system as recited in claim 4, said system further comprising a shut-off valve, said shut-off valve being adapted to control fluid flow from said system inlet to said filter assembly.

20. The filtered fluid storage and delivery system as recited in claim 19, wherein said shut-off valve is pressure controlled.

21. The filtered fluid storage and delivery system as recited in claim 20, said system further comprising a pressure feedback channel from said first chamber to said shut-off valve, said shut-off valve being controlled according to the fluid pressure within said first chamber.

22. The filtered fluid storage and delivery system as recited in claim 4, wherein said filter assembly comprises a deionizing filter.

23. The filtered fluid storage and delivery system as recited in claim 22, wherein said deionizing filter comprises a membrane separation filter.

24. The filtered fluid storage and delivery system as recited in claim 23, wherein said membrane separation filter comprises a reverse osmosis filter.

25. A filtered liquid storage and delivery system, said system comprising:
a system inlet for introduction to said system of a liquid;
a filter assembly for filtering of the introduced liquid, said filter assembly having a filter inlet in fluid communication with said system inlet and a filter outlet;
an accumulator having a first chamber in fluid communication with said filter outlet and a second chamber in selective fluid communication with said system inlet, said first chamber and said second chamber being segregated one from the other by a flexible membrane; and
a system outlet in fluid communication with said first chamber.

26. The filtered liquid storage and delivery system as recited in claim 25, said system further comprising a valve interposed said system inlet and said second chamber, said valve being adapted to selectively enable fluid communication between said system inlet and said second chamber.

27. The filtered liquid storage and delivery system as recited in claim 26, said system further comprising a first pressure relief, said first pressure relief being in fluid communication with said second chamber.

28. The filtered liquid storage and delivery system as recited in claim 27, wherein said first pressure relief is adapted to enable evacuation of liquid from said second chamber under pressure against said membrane from liquid entering said first chamber.

29. The filtered liquid storage and delivery system as recited in claim 28, wherein said first pressure relief comprises a capillary.

30. The filtered liquid storage and delivery system as recited in claim 27, said system further comprising a second pressure relief, said second pressure relief being in fluid communication with said first chamber.

31. The filtered liquid storage and delivery system as recited in claim 30, wherein said second pressure relief comprises a capillary.

32. The filtered liquid storage and delivery system as recited in claim 30, wherein said second pressure relief is balanced with said first pressure relief such that said second pressure relief resists greater pressure than does said first pressure relief.

33. The filtered liquid storage and delivery system as recited in claim 27, said system further comprising a shut-off valve, said shut-off valve being adapted to control liquid flow from said system inlet to said filter assembly.

34. The filtered liquid storage and delivery system as recited in claim 33, wherein said shut-off valve is pressure controlled.

35. The filtered liquid storage and delivery system as recited in claim 34, said system further comprising a pressure feedback channel from said first chamber to said shut-off valve, said shut-off valve being operable according to the fluid pressure within said first chamber.

36. The filtered liquid storage and delivery system as recited in claim 27, wherein said filter assembly comprises a reverse osmosis filter.

37. A filtered water storage and delivery system, said system comprising:
a system inlet for introduction to said system of tap water;
a reverse osmosis filter assembly for filtering of the introduced tap water, said reverse osmosis filter assembly having a filter inlet in fluid communication with said system inlet and a filter outlet for passage therefrom of filtered water;
an accumulator having a first chamber in fluid communication with said filter outlet and a second chamber in selective fluid communication with said system inlet, said first chamber and said second chamber being segregated one from the other by a flexible membrane; and
a system outlet in fluid communication with said first chamber for delivery of filtered water.

38. The filtered water storage and delivery system as recited in claim 37, said system further comprising a valve interposed said system inlet and said second chamber, said valve being adapted to selectively enable flow of tap water from said system inlet to said second chamber.

39. The filtered water storage and delivery system as recited in claim 38, wherein said valve comprises a solenoid controlled valve.

40. The filtered water storage and delivery system as recited in claim 38, said system further comprising a pressure relief, said pressure relief being in fluid communication with said second chamber.

41. The filtered water storage and delivery system as recited in claim 40, wherein said pressure relief is adapted to enable evacuation of tap water from said second chamber under pressure against said flexible membrane from filtered water entering said first chamber.

42. The filtered water storage and delivery system as recited in claim 41, wherein said pressure relief comprises a capillary.

43. The filtered water storage and delivery system as recited in claim 40, said system further comprising a shut-off valve, said shut-off valve being adapted to control flow of tap water from said system inlet to said reverse osmosis filter assembly.

44. The filtered water storage and delivery system as recited in claim 43, wherein said shut-off valve is pressure controlled.

45. The filtered water storage and delivery system as recited in claim 44, said system further comprising a pressure feedback channel from said first chamber to said shut-off valve, said shut-off valve being operable according to the pressure of filtered water passed from said filter outlet.
